(19) United States
(12) Patent Application Publication
(10) Pub. No.: US 2013/0086221 A1
(43) Pub. Date: Apr. 4, 2013

(54) IMAGE SHARING STORAGE DEVICE AND ITS EXECUTIVE METHOD

(71) Applicants: Hong-Chi Yu, Kaohsiung City (TW); Mao-Ting Chang, Kaohsiung City (TW)

(72) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/313,113

(22) Filed: Dec. 7, 2011

(30) Foreign Application Priority Data
Sep. 29, 2011 (TW) 100135176

(51) Int. Cl. G06F 15/16; H04N 5/225

(52) U.S. Cl. 709/219; 348/207.1; 348/E05.024

(57) ABSTRACT

The present invention provides an image sharing storage device and its executive method for image shared by local storage devices or remote servers and comprises at least an integrated circuit module and an application program. Any image could be recorded by one user who uses an image recording module of the application program and an image capture device of one computer when the integrated circuit module is electrically connected to the computer; the recorded image could be conveniently replayed by switching operational modes of the integrated circuit module via software or hardware.

### BACKGROUND OF THE INVENTION

1) Field of the Invention

The present invention relates to an image sharing storage device, especially a storage device switched between a read-only mode and a read/write mode.

2) Description of the Prior Art

Generally speaking, the images to be shared must be stored in on-line video sharing websites, mobile disks and flash disks in which those corresponding video sharing websites or actual mobile storage devices are informed of image data duplicated into facilities for sharing by one user via real-time communications software or e-mails and complete image sharing.

Notwithstanding the foregoing, there are some problems existing in on-line video sharing websites in use: (1) complicated operational procedure including images recorded by image recorder software first and images uploaded via web pages; (2) a string of video sharing websites to be remembered; (3) issues such as privacy and security of video sharing websites; (4) no real gifts perceived as traditional ones.

Furthermore, there are other correlative problems in methods for image data shared by substantial storage devices: (1) complicated operational procedure including images recorded by image recorder software first and stored in a substantial storage device; (2) risks of images erased; (3) higher price for one present to be given; (4) neither proprietary to own one present nor collecting value.

In the case of images shared privately, the above problems wait to be overcome for image sharing unrestricted to complicated operations, privacy or proprietary.

### SUMMARY OF THE INVENTION

To solve the above problems, the present invention provides an image sharing storage device comprising at least an integrated circuit module and an application program which can be used to quickly record and share images, simplify a traditional complicated procedure for image sharing, and complete switch between a read-only mode and a read/write mode in an integrated circuit module by means of the application program's switch module or an electrically conductive component for minimizing files mistakenly deleted and recorded images automatically replayed.

Accordingly, the principal object of the present invention is to provide an image sharing storage device which realizes sharing of private images easily, efficiently and conveniently without a complicated long-winded operational procedure.

The other object of the present invention is to provide an image sharing storage device which is able to protect recorded data.

The further object of the present invention is to provide an image sharing storage device which is effective in recorded video automatically replayed.

The yet other object of the present invention is to provide an image sharing storage device without a need to create an on-line account.

To this end, the present invention has the principal technical measures delivered with the following techniques. The present invention is an image sharing storage device which comprises at least an integrated circuit module and an application program: the integrated circuit module has at least an USB connector, at least a substrate, at least a controller and at least a memory wherein the substrate is used to carry the USB connector, the controller and the memory and allows the controller to be electrically connected between the USB connector and the memory via the substrate; the application program has an image recording module, a storage module and a switch module wherein the image recording module drives a computer's one image capture device, the storage module encodes the image caught by the image recording module and stores at least a recorded image, and the switch module activates the controller's one virtual device module.

The purposes and the technical issues with respect to the present invention are further embodied with the following technical measures.

In the said image sharing storage device, the integrated circuit module comprises at least a housing.

In the said image sharing storage device, the controller comprises a default device module which issues one demand for linking a virtual CD-ROM drive and a storage disk to one computer and deactivates the default device module with the virtual device module activated.

In the said image sharing storage device, the memory comprises at least an authentication code and the application program comprises a network module which is used to upload both the authentication code and the recorded image to a server and retrieve a website returned from the server.

In the said image sharing storage device, the virtual device module could be a virtual CD-ROM drive or a virtual keypad.

In the said image sharing storage device, the application program comprises a browser module which depends on the mode for program call to activate the website when the virtual device module is a virtual CD-ROM drive.

In the said image sharing storage device, the controller comprises a keypad module which depends on the mode for keyboard input to activate the website when the virtual device module is a virtual keypad.

In the said image sharing storage device, the memory comprises a storage space which is used to save the recorded image.

In the said image sharing storage device, the computer has one storage device which comprises a storage space used to store the recorded image.

The purposes and the technical issues with respect to the present invention are further embodied with the following other technical measures.

The present invention is an image sharing storage device which comprises at least an integrated circuit module, an application program and at least an electrically conductive component: the integrated circuit module has at least an USB connector, at least a substrate, at least a controller and at least a memory wherein the substrate is used to carry the USB connector, the controller and the memory and allows the controller to be electrically connected between the USB connector and the memory via the substrate; the application program has an image recording module and a storage module wherein the image recording module drives a computer's one image capture device and the storage module encodes the image caught by the image recording module and stores at least a recorded image; the electrically conductive component adheres to at least an electrically conductive contact on the substrate for the electrically conductive component electrically connected to the electrically conductive contacts by which the controller's virtual device module is activated.

The purposes and the technical issues with respect to the present invention are further embodied with the following technical measures.

In the said image sharing storage device, the integrated circuit module comprises at least a housing.

In the said image sharing storage device, the controller comprises a default device module which issues one demand for linking a virtual CD-ROM drive and a storage disk to one computer and deactivates the default device module with the virtual device module activated.

In the said image sharing storage device, the memory comprises at least an authentication code and the application program comprises a network module which is used to upload both the authentication code and the recorded image to a server and retrieve a website returned from the server.

In the said image sharing storage device, the virtual device module could be a virtual CD-ROM drive or a virtual keypad.

In the said image sharing storage device, the application program comprises a browser module which depends on the mode for program call to activate the website when the virtual device module is a virtual CD-ROM drive.

In the said image sharing storage device, the controller comprises a keypad module which depends on the mode for keyboard input to activate the website when the virtual device module is a virtual keypad.

In the said image sharing storage device, the memory comprises a storage space which is used to save the recorded image.

In the said image sharing storage device, the computer has one storage device which comprises a storage space used to store the recorded image.

An executive method of the image sharing storage device in the present invention includes steps as follows. Step a: An USB connector of an integrated circuit module is electrically connected to an USB port on a computer; Step b: A demand from a default device module of a controller for linking a virtual CD-ROM drive and a storage disk is issued to the computer and an application program is automatically executed by the computer; Step c: An image recording module is executed by the application program and an image caught by an image capture device is encoded by a storage module for at least a recorded image saved in a storage space; Step d: The USB connector is separated from the USB port; Step e: The USB connector of the integrated circuit module is electrically connected to the USB port on the computer.

The executive method for the present invention is further realized with the following technical measures.

In the said executive method of the image sharing storage device, a switch module of the application program is executed after Step c in order to deactivate the default device module of the controller and activate a virtual device module.

In the said executive method of the image sharing storage device, a network module of the application program is executed after Step c for both an authentication code and the recorded image uploaded to a server and a website which is returned from the server saved in the storage disk.

In the said executive method of the image sharing storage device, an electrically conductive component is removed from an electrically conductive contact after Step d in order to deactivate the default device module and activate a virtual device module.

In the said executive method of the image sharing storage device, a demand from the virtual device module of the controller for linking a virtual CD-ROM drive after Step e is issued to the computer for the application program automatically executed by the computer and default media player software called by the application program to read and indicate the recorded image on a display unit.

In the said executive method of the image sharing storage device, a demand from the virtual device module of the controller for linking a virtual CD-ROM drive is issued to the computer for the application program automatically executed by the computer, a default browser called by the application program to access one website, and the recorded image indicated on the website via the browser.

In the said executive method of the image sharing storage device, a demand from the virtual device module of the controller for linking a virtual keypad is issued to the computer after Step e for a default browser automatically activated by the computer to access a website and the recorded image indicated on the website via the browser.

In contrast to the prior arts, the present invention is effective in: (1) private images quickly, easily, effectively and conveniently recorded and shared by the application program; (2) recorded private images taken as read-only files for complete protection; (3) accessibility and affinity owing to shareable privately-recorded images ready to be automatically replayed by a virtual CD-ROM drive or a virtual keypad; (4) any private images uploaded by one user via Internet accessible to one computer for data sharing without an account, minimized steps for sharing, and image simply shared by one user at any place anytime.

### BRIEF DESCRIPTIONS OF THE DRAWINGS

FIG. 1 illustrates the cross-sectional views of the first, second, third and fourth embodiments in the present invention.

FIG. 2 illustrates the cross-sectional view of the fourth embodiment in the present invention.

FIG. 3 is the block diagram of the first embodiment in the present invention.

FIG. 4 is the block diagram of the second embodiment in the present invention.

FIG. 5 is the block diagram of the third embodiment in the present invention.

FIG. 6 is the block diagram of the fourth embodiment in the present invention.

FIG. 7a illustrates the block diagram of the default device module without networks connected in the present invention.

FIG. 7b illustrates the block diagram of the virtual device module without networks connected in the present invention.

FIG. 7c illustrates the block diagram of the default device module with networks connected in the present invention.

FIG. 7d illustrates the block diagram of the virtual device module with networks connected in the present invention.

FIG. 7e illustrates the block diagram of the virtual keypad and the keypad module in the present invention.

FIG. 8 illustrates the flow diagram of the first embodiment in the present invention.

FIG. 9 illustrates the flow diagram of the second embodiment in the present invention.

FIG. 10 illustrates the flow diagram of the third embodiment in the present invention.

FIG. 11 illustrates the flow diagram of the fourth embodiment in the present invention.

### DETAILED DESCRIPTIONS OF THE PREFERRED EMBODIMENTS

For objects, characteristics, and effects obviously and easily understood, the preferred embodiments of the present invention are particularly interpreted as follows:

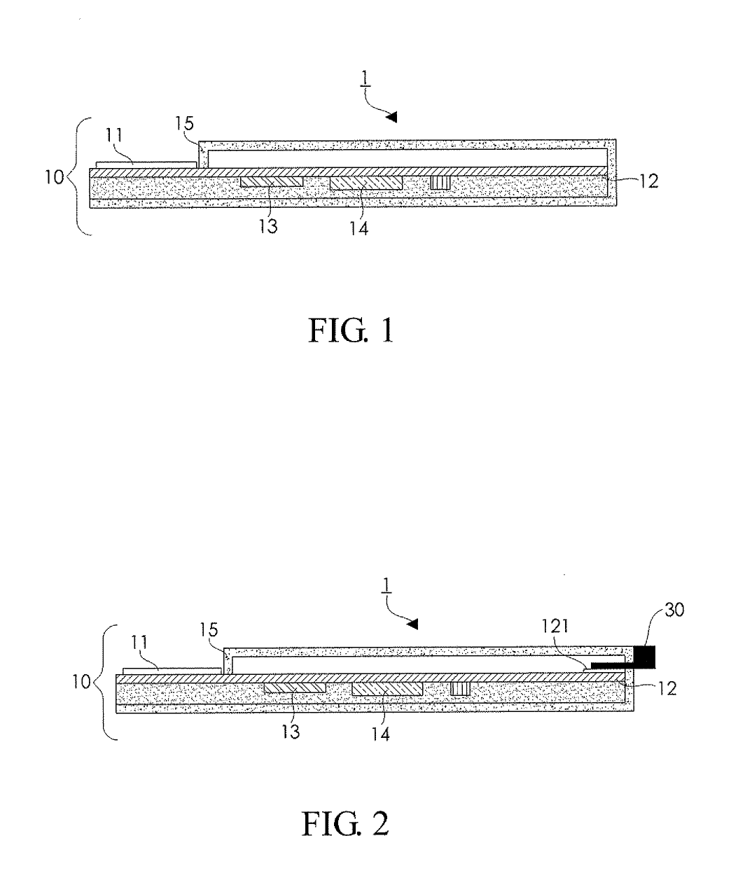

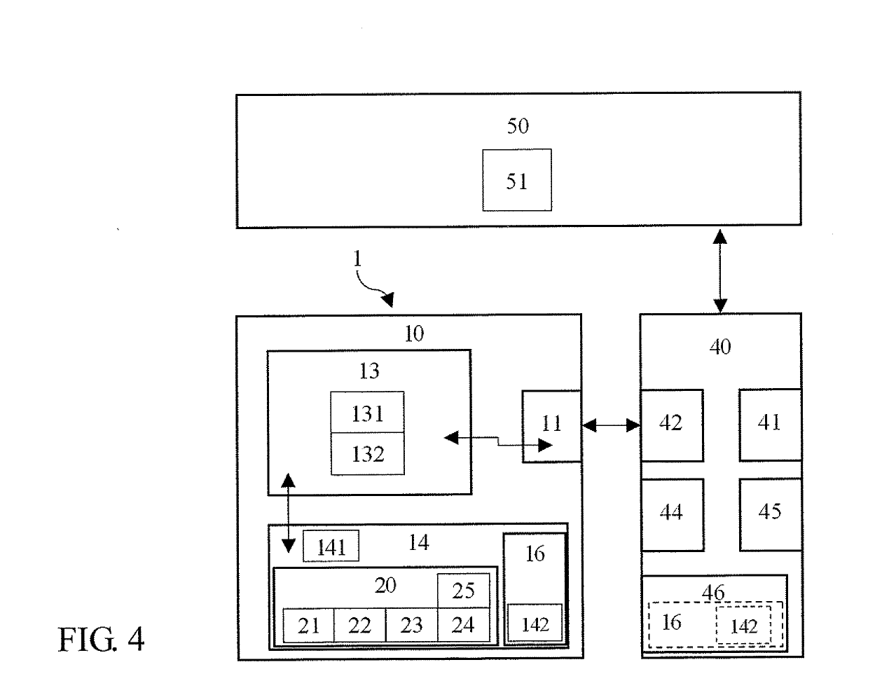

The first embodiment in the present invention of an image sharing storage device (1) and its executive method is indicated in FIGS. 1, 3 and 8. Referring to FIGS. 1 and 3 which illustrate the present invention comprises at least an integrated circuit module (10) and an application program (20):

The integrated circuit module (10) comprises at least an USB connector (11), at least a substrate (12), at least a controller (13) and at least a memory (14). In this embodiment, the substrate (12) is a wire board, preferably a printed circuit board (PCB) such as a single layer PCB or a multi-layer PCB. Wherein, the substrate (12) has an upper surface corresponding to an underside where a plurality of fingers are disposed in the upper surface. Moreover, in the other embodiment, the substrate could be a lead frame, Polyimide, BT or the other kind of wafer substrate. Wherein the substrate (12) is used to carry the USB connector (11), the controller (13) and the memory (14) for the controller (13) electrically connected between the USB connector (11) and the memory (14) via the substrate (12) and the controller (13) has a virtual device module (131).

Specifically, the USB connector (11) is electrically connected to an USB port (42) of a computer (40); the substrate (12) comprises at least a passive component (not shown in figures); the controller (13) is used to control data processing and access; the memory (14) is used in providing readable/writable digital data; the virtual device module (131) is used to issue one demand for linking a CD-ROM drive or a keypad to the computer (40) with the integrated circuit module (10) and the computer (40) electrically connected each other.

Preferably, the integrated circuit module (10) comprises at least a housing (15) used to make sure of reliability of the integrated circuit module (10). The controller (13) comprises a default device module (132) which issues a demand to the computer (40) for linking a virtual CD-ROM drive (1321) as well as a storage disk (1322) and deactivate the default device module (132) with the virtual device module (131) activated.

The application program (20) comprises an image recording module (21), a storage module (22) and a switch module (23): the image recording module (21) drives an image capture device (41) of a computer (40); the storage module (22) encodes an image which has been caught by the image recording module (41) and saves at least a recorded image (142); the switch module (23) is capable of activating the virtual device module (131).

In detail, the application program (20) is software which comprises a user interface and is downloaded from Internet or stored in a local storage device. The image recording module (21) is one software module used to catch video/audio signals based on hardware devices in the computer (40). The storage module (22) is one software module which compresses video/audio signals caught by the image recording module (21) and saves them as compressed multimedia files in a storage device. The computer (40) is one machine which depends on a series of electronics-based commands for data processing. The recorded image (142) is saved in a storage space (16) which is arranged in the memory (14) or a storage device (46) of the computer (40). The switch module (23) is one software module based on software to operate the controller (13). In this embodiment, the application program (20) is saved in the virtual CD-ROM drive (1321) for convenience; the storage space (16) is designed in the memory (14) for mobility.

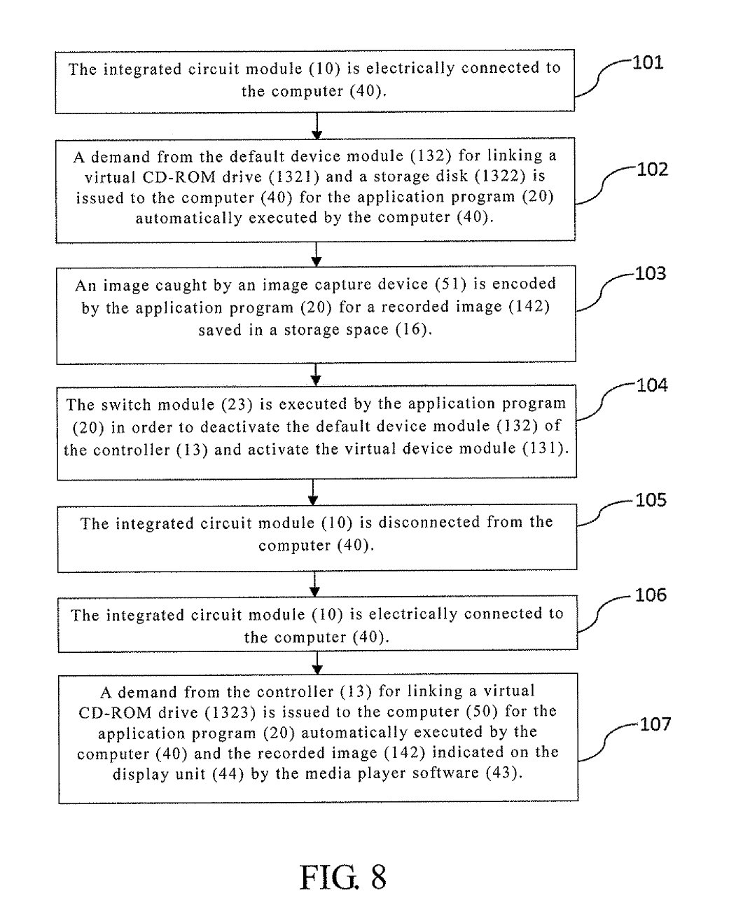

Referring to FIG. 8 which illustrates the executive method for the first embodiment of the present invention includes steps as follows: The USB connector (11) of the integrated circuit module (10) is electrically connected to the USB port (42) of the computer (40) (Step 1: 101);

A demand from the default device module (132) of the controller (13) for linking a virtual CD-ROM drive (1321) and a storage disk (1322) is issued to the computer (40) for the application program (20) automatically executed by the computer (40) (Step 2: 102);

An image recording module (31) is executed by the application program (20) and an image caught by an image capture device (41) is encoded by a storage module (22) for a recorded image (142) saved in a storage space (16) (Step 3: 103);

The switch module (23) is executed by the application program (20) in order to deactivate the default device module (132) of the controller (13) and activate the virtual device module (131) (Step 4: 104);

The USB connector (11) is separated from the USB port (42) (Step 5: 105);

The USB connector (11) of the integrated circuit module (10) is electrically connected to the USB port (41) of the computer (40) (Step 6: 106); and

A demand from the virtual device module (131) of the controller (13) for linking a virtual CD-ROM drive (1323) is issued to the computer (50) for the application program (20) automatically executed by the computer (40), the default media player software (43) called by the application program (20) to access the recorded image (142), and the recorded image (142) indicated on the display unit (44) by the media player software (43) (Step 7: 107).

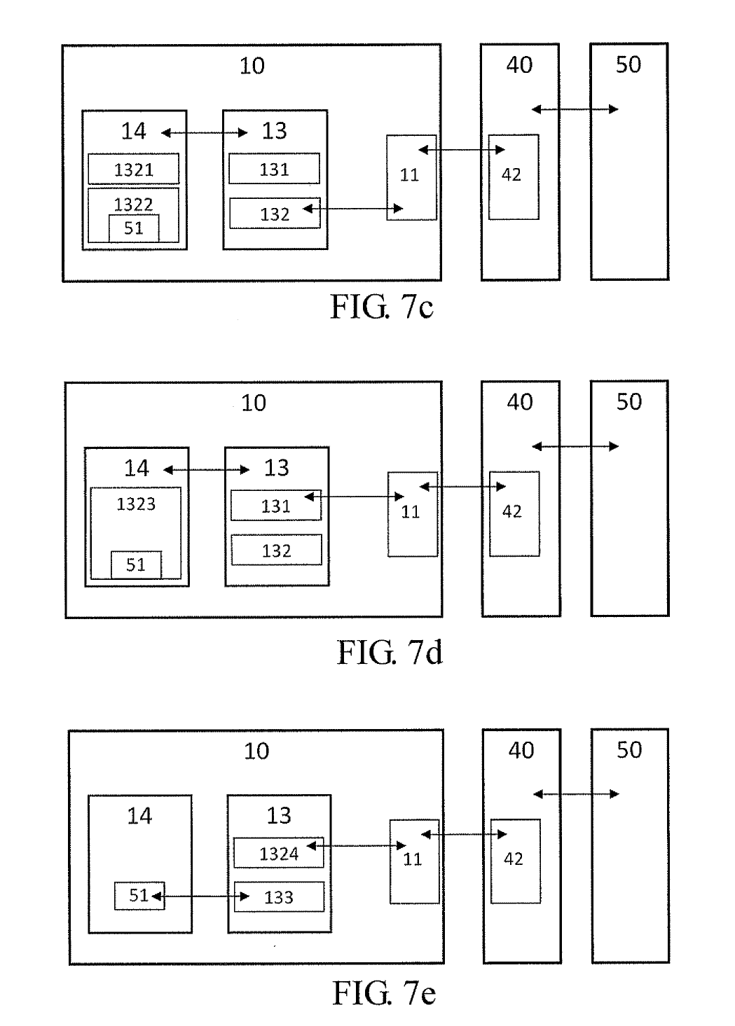

As shown in FIG. 7a, the specific process for the default device module (132) is made up of the USB connector (11) and the USB port (42) electrically connected each other, the memory (14) partitioned to a virtual CD-ROM drive (1321) and a virtual disk (1322) by the default device module (132) of the controller (13), and both the virtual CD-ROM drive (1321) and the virtual disk (1322) connected to the computer (40).

As shown in FIG. 7b, the detailed process for the virtual CD-ROM drive (1323) of the virtual device module (131) is made up of both the USB connector (11) and the USB port (42) electrically connected to the computer (40), the memory (14) partitioned to the virtual CD-ROM drive (1323) by the virtual device module (131) of the controller (13), and the recorded image (142) read by the computer (40) which is connected to the virtual CD-ROM drive (1323).

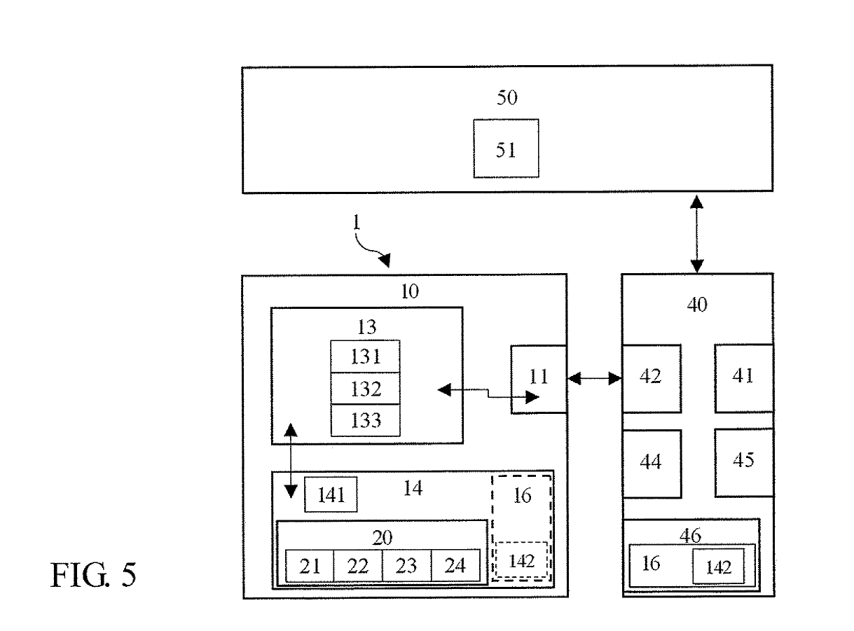

Referring to FIGS. 1, 4 and 9 which illustrate the second embodiment in the present invention of an image sharing storage device (1) and its executive method wherein those structural characteristics described in the first embodiment and FIGS. 1, 3 and 8 are marked with the same symbols and not repeatedly interpreted. The difference between the second embodiment and the first one is the former's memory (14) and application program (20) comprise an authentication code (141) and a network module (24) respectively and the former has a server (51) connected to networks.

Specifically, the network module (24) is used to upload both the authentication code (141) and the recorded image (142) to a server (50) and save a website (51) returned from the server (50) in a storage space (1322).

As shown in FIG. 7c, the specific process for the default device module (132) is made up of both the USB connector (11) and the USB port (42) electrically connected to the computer (40), the memory (14) partitioned to a virtual CD-ROM drive (1321) and a virtual disk (1322) by the default device module (132) of the controller (13), and both the virtual CD-ROM drive (1321) and the virtual disk (1322) connected to the computer (40) for the application program (20) executed and the website (51) returned from the server (50) saved in the storage space (1322).

As shown in FIG. 7d, the detailed process for the virtual CD-ROM drive (1323) of the virtual device module (131) is made up of both the USB connector (11) and the USB port (42) electrically connected to the computer (40), the memory (14) partitioned to a virtual CD-ROM drive (1323) by the virtual device module (131) of the controller (13), and the website (51) accessed by the computer (40) connected to the virtual CD-ROM drive (1323).

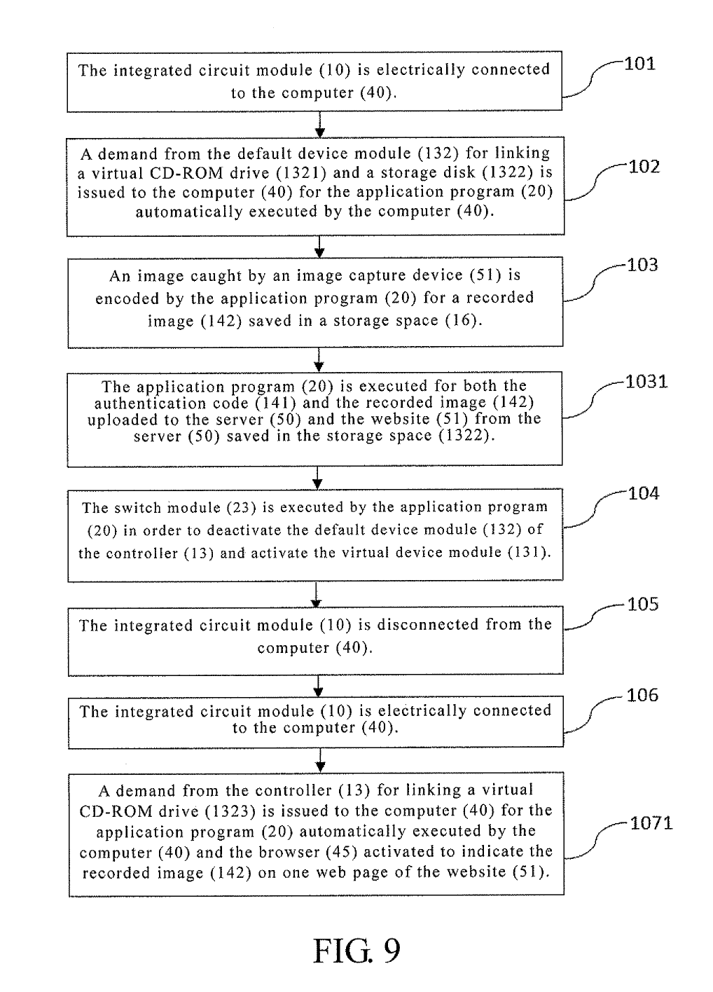

Preferably, referring to FIG. 9 which illustrates the executive method for the second embodiment of the present invention includes steps as follows: The USB connector (11) of the integrated circuit module (10) is electrically connected to the USB port (42) of the computer (40) (Step 1: 101);

A demand from the default device module (132) of the controller (13) for linking a virtual CD-ROM drive (1321) and a storage disk (1322) is issued to the computer (40) for the application program (20) automatically executed by the computer (40) (Step 2: 102);

The image recording module (31) is executed by the application program (20) and an image caught by the image capture device (41) is encoded by the storage module (22) for the recorded image (142) saved in the storage space (16) (Step 3: 103);

The application program (20) is executed for both the authentication code (141) and the recorded image (142) uploaded to the server (50) and the website (51) from the server (50) saved in the storage space (1322) (Step 4: 1031);

The switch module (23) of the application program (20) is executed for the default device module (132) of the controller (13) deactivated and the virtual device module (131) activated (Step 5: 104);

The USB connector (11) is separated from the USB port (42) (Step 6: 105);

The USB connector (11) of the integrated circuit module (10) is electrically connected to the USB port (41) of the computer (40) (Step 7: 106); and

A demand from the controller (13) for linking a virtual CD-ROM drive (1323) is issued to the computer (40) for the application program (20) automatically executed by the computer (40) and a browser (45) activated to indicate the recorded image (142) on one web page of the website (51) (Step 8: 1071).

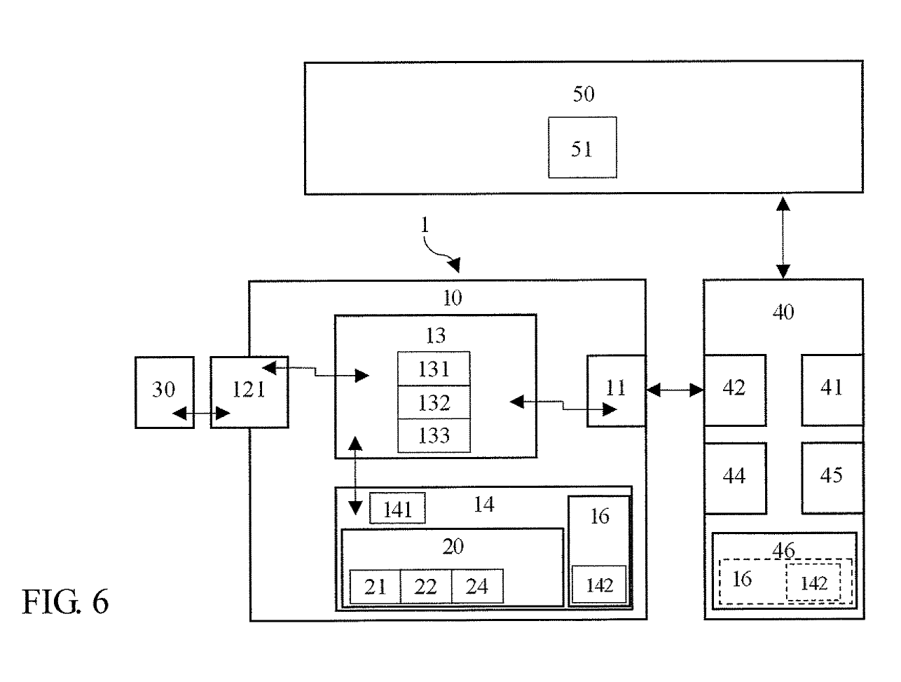

Referring to FIGS. 1, 5 and 10 which illustrate the third embodiment in the present invention of an image sharing storage device (1) and its executive method wherein those structural characteristics described in both the first and the second embodiments (FIGS. 1, 3, 4, 8 and 9) are marked with the same symbols and not repeatedly interpreted. The difference between the third embodiment and the second one is a demand from the former's virtual device module (131) for linking a virtual keypad (1324) is issued to the computer (40) via characters entered with a keypad module (133).

Specifically, the controller (13) comprises a keypad module (133) which depends on the mode for keyboard input to activate the website (51), when the virtual device module (131) is a virtual keypad.

As shown in FIG. 7e, the detailed process for the virtual keypad (1324) of the virtual device module (131) is made up of both the USB connector (11) and the USB port (42) electrically connected to the computer (40), the virtual keypad (1324) connected via the virtual device module (131) of the controller (13), the data of website (51) in the memory (14) accessed by the keypad module (133), and the website (51) entered via a keypad.

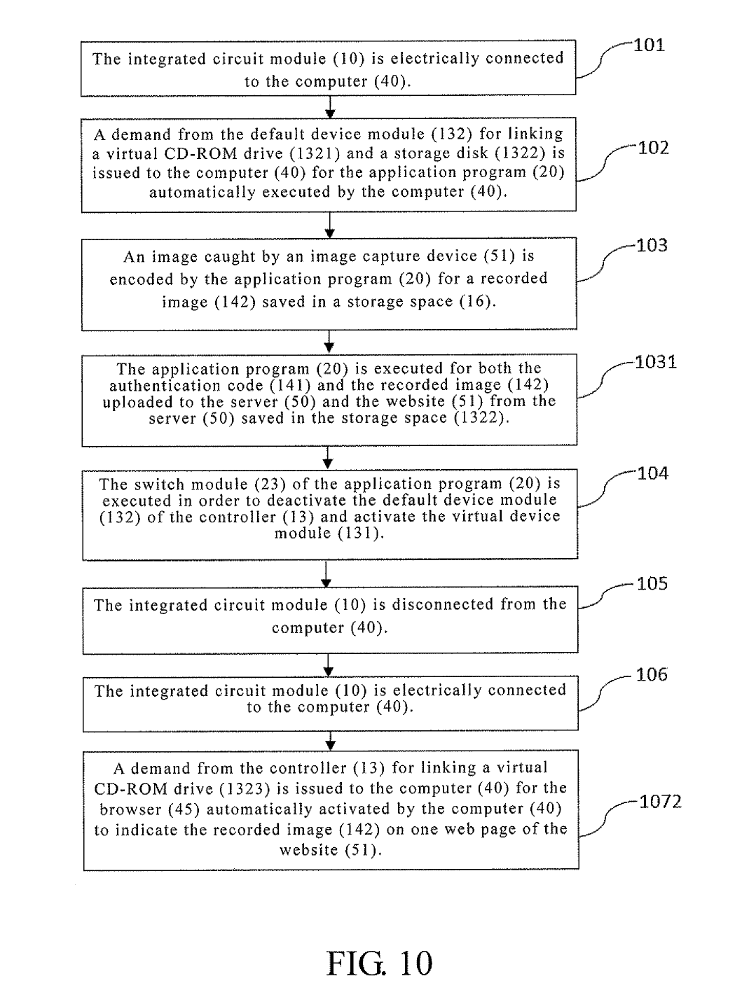

Preferably, referring to FIG. 10 which illustrates the executive method of the third embodiment in the present invention comprises steps as follows: The USB connector (11) of the integrated circuit module (10) is electrically connected to the USB port (42) of the computer (40) (Step 1: 101);

A demand from the default device module (132) of the controller (13) for linking both a virtual CD-ROM drive (1321) and a storage disk (1322) is issued to the computer (40) for the application program (20) automatically executed by the computer (40) (Step 2: 102);

The image recording module (31) is executed by the application program (20) for an image, which is caught by the image capture device (41), encoded by the storage module (22) and the recorded image (142) saved in the storage space (16) (Step 3: 103);

The application program (20) is executed for both the authentication code (141) and the recorded image (142) uploaded to the server (50) and the website (51) from the server (50) saved in the storage space (1322) (Step 4: 1031);

The switch module (23) of the application program (20) is executed for the default device module (132) of the controller (13) deactivated and the virtual device module (131) activated (Step 5: 104);

The USB connector (11) is separated from the USB port (42) (Step 6: 105);

The USB connector (11) of the integrated circuit module (10) is electrically connected to the USB port (41) of the computer (40) (Step 7: 106); and

A demand from the controller (13) for linking a virtual keypad (1324) is issued to the computer (40) for the browser (45) automatically activated by the computer (40) and the recorded image (142) indicated on a web page of the website (51) (Step 8: 1072).

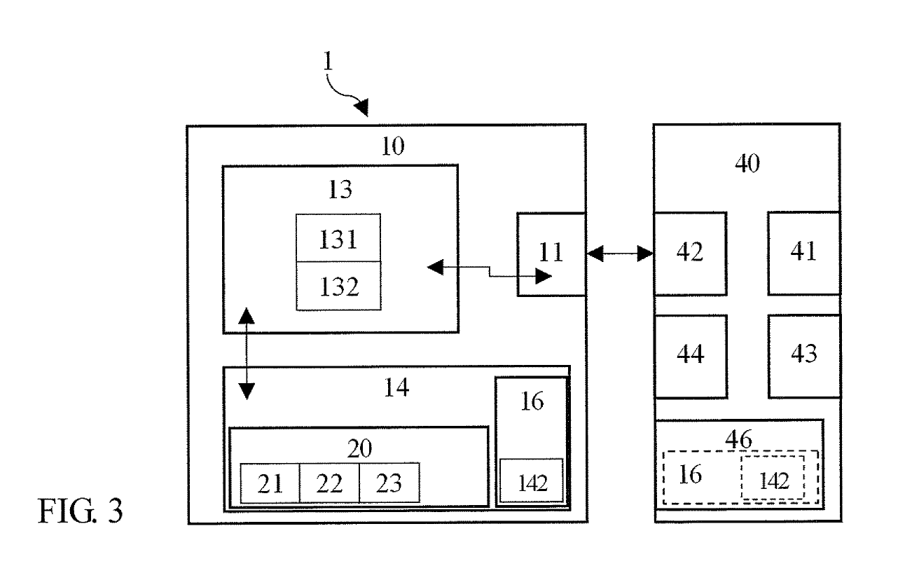

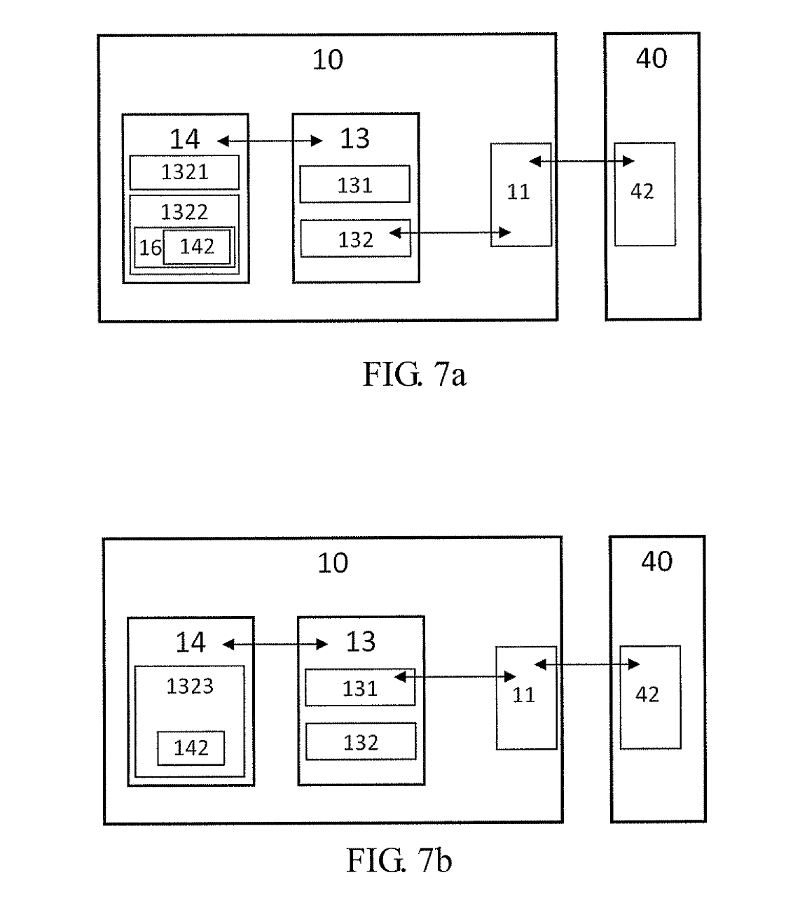

Referring to FIGS. 2, 6 and 11 which illustrate the fourth embodiment in the present invention of an image sharing storage device (1) and its executive method wherein the structural characteristics described from the first embodiment to the third one (FIGS. 1, 3, 4, 5, 8, 9 and 10) are marked with the same symbols and not repeatedly interpreted. The difference between the fourth embodiment and the third one is the former's integrated circuit module (10) comprising both electrically conductive contacts (121) and an electrically conductive component (30), one application program (20) without a switch module (23), and one storage space (16) inside the storage device (46).

Specifically, the electrically conductive component (30) adheres to at least one electrically conductive contact (121) on the substrate (12) for the electrically conductive component (30) electrically connected to the electrically conductive contact (121) and the electrically conductive contact (121) used to activate a virtual device module (131) of the controller (13).

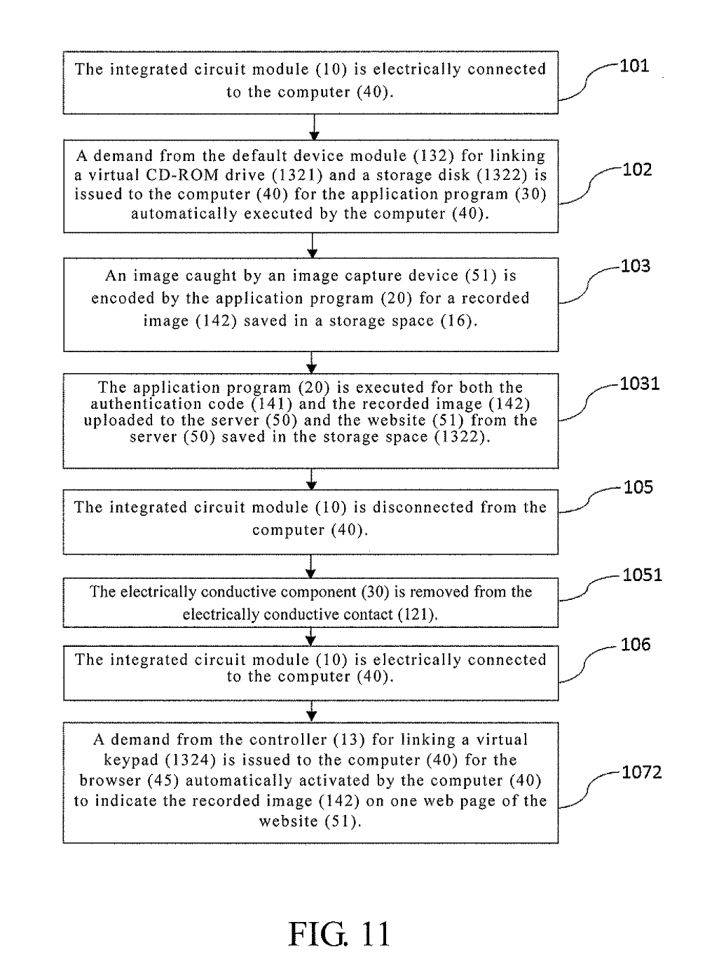

Preferably, referring to FIG. 11 which illustrates the executive method for the third embodiment of the present invention comprises steps as follows: The USB connector (11) of the integrated circuit module (10) is electrically connected to the USB port (42) of the computer (40) (Step 1: 101);

A demand from the default device module (132) of the controller (13) for linking both a virtual CD-ROM drive (1321) and a storage disk (1322) is issued to the computer (40) for the application program (20) automatically executed by the computer (40) (Step 2: 102);

The image recording module (31) is executed by the application program (20) and an image caught by the image capture device (41) is encoded by the storage module (22) for the recorded image (142) saved in the storage space (16) (Step 3: 103);

The application program (20) is executed for both the authentication code (141) and the recorded image (142) uploaded to the server (50) and the website (51) from the server (50) saved in the storage space (1322) (Step 4: 1031);

The USB connector (11) is separated from the USB port (42) (Step 5: 105);

The electrically conductive component (30) is removed from the electrically conductive contact (121) (Step 6: 1051);

The USB connector (11) of the integrated circuit module (10) is electrically connected to the USB port (41) of the computer (40) (Step 7: 106); and

A demand from the controller (13) for linking a virtual keypad (1324) is issued to the computer (40) for the browser (45) automatically activated by the computer (40) and the recorded image (142) displayed on a web page of the website (51) (Step 8: 1072).

Therefore, it can be seen from the descriptions summarized above that the present invention is to provide an image sharing storage device (1) and its executive method for image conveniently shared by local storage devices via Internet and a user experiencing switched user modes via software or hardware.

Accordingly, the present invention with some effects different from general image sharing and referred to as creative work meets patentability and is applied for the patent.

It must be stressed that the said disclosures demonstrate the preferred embodiments of the present invention only and any equivalent change in disclosures, claims or drawings with respect to the present invention is still within the technical scope protected by the present invention which refers to claims hereinafter.

What is claimed is:

1. An image sharing storage device (1) comprises at least an integrated circuit module (10) and an application program (20):
The integrated circuit module (10) comprises at least an USB connector (11), at least a substrate (12), at least a controller (13) and at least a memory (14) wherein the substrate (12) is used to carry the USB connector (11), the controller (13) and the memory (14) and the controller (13) is electrically connected between the USB connector (11) and the memory (14) via the substrate (12);
The application program (20) comprises an image recording module (21), a storage module (22) and a switch module (23): the image recording module (21) is used to drive an image capture device (41) of a computer (40); the storage module (22) encodes an image caught by the image recording module (41) and saves at least a recorded image (142); the switch module (23) is used to activate a virtual device module (131) of the controller (13).

2. The image sharing storage device (1) according to claim 1 wherein the controller (13) comprises a default device module (132) which issues one demand for linking a virtual CD-ROM drive (1321) and a storage disk (1322) to the computer (40) and deactivates the default device module (132) with the virtual device module (131) activated.

3. The image sharing storage device (1) according to claim 1 wherein the memory (14) comprises at least an authentication code (141) and the application program (20) comprises a network module (24) which is used to upload both the authentication code (141) and the recorded image (142) to a server (50) and get a website (51) returned from the server (50).

4. The image sharing storage device (1) according to claim 3 wherein the application program (20) comprises a browser module (25) which depends on the mode for program call to activate the website (51) when the virtual device module (131) is a virtual CD-ROM drive.

5. The image sharing storage device (1) according to claim 3 wherein the controller (13) comprises a keypad module (133) which depends on the mode keyboard input to activate the website (51) when the virtual device module (131) is a virtual keypad.

6. The image sharing storage device (1) according to claim 1 wherein the computer (40) comprises a storage space (16) which is used to save the recorded image (142).

7. An image sharing storage device (1) comprises at least an integrated circuit module (10), an application program (20) and at least an electrically conductive component (30):
The integrated circuit module (10) comprises at least an USB connector (11), at least a substrate (12), at least a controller (13) and at least a memory (14) wherein the substrate (12) is used to carry the USB connector (11), the controller (13) and the memory (14), and the controller (13) is electrically connected between the USB connector (11) and the memory (14) via the substrate (12);
The application program (20) comprises an image recording module (21) and a storage module (22): the image recording module (21) is used to drive an image capture device (41) of a computer (40); the storage module (22) encodes an image caught by the image recording module (41) and saves at least a recorded image (142);
The electrically conductive component (30) adheres to at least one electrically conductive contact (121) on the substrate (12) for the electrically conductive component (30) electrically connected to the electrically conductive contacts (121) which are used to activate a virtual device module (131) of the controller (13).

8. The image sharing storage device (1) according to claim 7 wherein the controller (13) comprises a default device module (132) which issues one demand for linking a virtual CD-ROM drive (1321) and a storage disk (1322) to the computer (40) and deactivates the default device module (132) with the virtual device module (131) activated.

9. The image sharing storage device (1) according to claim 7 wherein the memory (14) comprises at least an authentication code (141) and the application program (20) comprises a network module (24) which is used to upload both the authentication code (141) and the recorded image (142) to a server (50) and get a website (51) returned from the server (50).

10. The image sharing storage device (1) according to claim 9 wherein the application program (20) comprises a browser module (25) which depends on the mode for program call to activate the website (51) when the virtual device module (131) is a virtual CD-ROM drive.

11. The image sharing storage device (1) according to claim 9 wherein the controller (13) comprises a keypad module (133) which depends on the mode keyboard input to activate the website (51) when the virtual device module (131) is a virtual keypad.

12. The image sharing storage device (1) according to claim 7 wherein the computer (40) comprises a storage space (16) which is used to save the recorded image (142).

13. An executive method of the image sharing storage device (1) comprises steps as follows:
Step a: An USB connector (11) of an integrated circuit module (10) is electrically connected to an USB port (42) of a computer (40);
Step b: A demand from a default device module (132) of a controller (13) for linking a virtual CD-ROM drive (1321) and a storage disk (1322) is issued to the computer (40) for an application program (20) automatically executed by the computer (40);
Step c: An image recording module (31) is executed by the application program (20) and an image caught by an image capture device (41) is encoded by a storage module (22) for at least a recorded image (142) saved in a storage space (16);
Step d: The USB connector (11) is separated from the USB port (42); and
Step e: The USB connector (11) of the integrated circuit module (10) is electrically connected to the USB port (41) of the computer (40).

14. The executive method of the image sharing storage device (1) according to claim 11 wherein a switch module (23) of the application program (20) is executed after Step c for the default device module (132) of the controller (13) deactivated and a virtual device module (131) activated.

15. The executive method of the image sharing storage device (1) according to claim 11 wherein a network module (24) of the application program (20) is executed after Step c for both an authentication code (141) and the recorded image (142) uploaded to a server (50) and a website (51) returned from the server (50) saved in the storage disk (1322).

16. The executive method of the image sharing storage device (1) according to claim 11 wherein an electrically conductive component (30) is removed from an electrically conductive contact (121) after Step d for the default device module (132) of the controller (13) deactivated and a virtual device module (131) activated.

17. The executive method of the image sharing storage device (1) according to claim 11 wherein the virtual device module (131) of the controller (13) issues one demand for linking a virtual CD-ROM drive (1323) to the computer (50) for the application program (20) automatically executed by the computer (40), default media player software (43) called by the application program (20) to access the recorded image (142), and the recorded image (142) displayed on a display unit (44) by the media player software (43).

18. The executive method of the image sharing storage device (1) according to claim 11 wherein the virtual device module (131) of the controller (13) issues one demand for linking a virtual CD-ROM drive (1323) to the computer (40) which will automatically execute the application program (20) for a default browser (55) called by the application program (20) to read a website (51) and the recorded image (142) displayed on one web page of the website (51).

19. The executive method of the image sharing storage device (1) according to claim 11 wherein the virtual device module (131) of the controller (13) issues one demand for linking a virtual keypad (1324) after Step e to the computer (40) which will automatically activate a default browser (45) for import of a website (51) and the recorded image (142) displayed on one web page of the website (51) by the browser (45).
